(19) United States
(12) Patent Application Publication
(10) Pub. No.: US 2011/0069934 A1
(43) Pub. Date: Mar. 24, 2011

(54) APPARATUS AND METHOD FOR PROVIDING OBJECT BASED AUDIO FILE, AND APPARATUS AND METHOD FOR PLAYING BACK OBJECT BASED AUDIO FILE

(75) Inventors: Tae Jin LEE, Daejeon (KR); In Seon Jang, Daejeon (KR); Jeong Il Seo, Daejeon (KR); Yong Ju Lee, Daejeon (KR); Seung Kwon Beack, Seoul (KR); Jae Hyoun Yoo, Daejeon (KR); Min Je Kim, Daejeon (KR); Dae Young Jang, Daejeon (KR); Kyeong Ok Kang, Daejeon (KR); Jin Woo Hong, Daejeon (KR); Jin Woong Kim, Daejeon (KR)

(73) Assignee: Electronics and Telecommunications Research Institute, Daejeon (KR)

(21) Appl. No.: 12/887,810

(22) Filed: Sep. 22, 2010

(30) Foreign Application Priority Data
Sep. 24, 2009 (KR) 10-2009-0090358
Oct. 19, 2009 (KR) 10-2009-0099155
Aug. 26, 2010 (KR) 10-2010-0082997

(51) Int. Cl. H04N 9/80

(52) U.S. Cl. 386/241

(57) ABSTRACT

Provided are an apparatus and method for providing an object based audio file, and an apparatus and method for playing back an object based audio file. The object based audio file producing apparatus may include a bitstream generator to generate a bitstream about an object based audio file including a plurality of audio object frames and a file header for an object based audio service; and a bitstream transmitter to transmit the bitstream to the object based audio file playback apparatus. The plurality of audio object frames may include a frame storing a audio source in which all of a plurality of audio frames is mixed and a frame storing each of the audio objects.

### CROSS-REFERENCE TO RELATED APPLICATIONS

This application claims the benefit of Korean Patent Application No. 10-2009-0090358, filed on Sep. 24, 2009, Korean Patent Application No. 10-2009-0099155, filed on Oct. 19, 2009, and Korean Patent Application No. 10-2010-0082997, filed on Aug. 26, 2010, in the Korean Intellectual Property Office, the disclosures of which are incorporated herein by reference.

### BACKGROUND

1. Field of the Invention

The present invention relates to an apparatus and method for providing an object based audio file, and an apparatus and method for playing back an object based audio file, and more particularly, to an apparatus and method that enables a low-performance user terminal for a backward compatibility to provide an object based audio service.

2. Description of the Related Art

An audio file provided using a broadcasting service such as television (TV) broadcasting, radio broadcasting, Digital Multimedia Broadcasting (DMB) broadcasting, and the like may be transmitted and be stored as a single audio file in which a plurality of audio sources is mixed. Here, a audio source may correspond to an audio object. In such broadcasting service environment, a user may adjust a strength of the entire audio file and the like. However, the user may not control a characteristic of audio file for each of the audio objects. For example, the user may not adjust a strength of audio file for each of the audio objects included in the audio file.

When generating a single audio file, audio file for each of the audio objects may not be entirely mixed with each other, however, may be individually stored. In this case, the user may easily control a strength of audio file for each of the audio objects using an audio file playback apparatus. As described above, a service for enabling a storage/providing end to independently store and transmit a plurality of audio files so that the user may appropriately control audio file for each of the audio objects using a playback apparatus is referred to as an object based audio service.

According to the object based audio service, characteristics of audio objects to corresponding to collected audio sources, such as a position of each audio object, a sound strength, and the like may be defined as a preset and thereby be used to play back an audio. For example, when a plurality of presets associated with audio objects is generated, is included in an audio file, and thereby is stored in the audio file, the user may more effectively utilize the object based audio service. When the object based audio service is applied to an album, a variety of audio objects such as a vocal, a drum, a piano, and the like may be stored without being entirely mixed, and an editor may store presets together with the audio objects using a variety of schemes of mixing the audio objects and thereby provide, to the user, the audio objects with the presets. The user may select a single preset from the presets edited by the user. Also, the user may generate presets by directly controlling each of audio objects and thereby generate the user's desired style of music.

For the object based audio service, an audio file may include a plurality of audio tracks and a preset associated with control information of each audio track. Here, an audio track may correspond to an audio object. The user may play back an audio track included in the audio file, using mixing.

However, when the object based audio service is applied to a user terminal, problems may occur. In particular, when the user terminal is a mobile terminal, a processing throughput of the mobile terminal may be relatively low compared to general audio file playback apparatuses and thus, it may be difficult to effectively provide an object based audio service. For example, when the user terminal having a low audio file processing throughput is capable of playing back only a maximum of two audio objects, the object based audio service may not be provided to the user terminal in a current bitstream structure. In addition, the user terminal incapable of performing the object based audio service may not perform an entirely mixed object based audio service.

Also, when the user terminal is incapable of performing the object based audio service, the user terminal may parse an object based audio file, however, may not decode to audio objects at the same time. For example, when the user terminal performs an existing audio service, decoding may be sequentially performed with respect to audio tracks included in the audio file and thus, a plurality of audio tracks may not be simultaneously decoded.

Accordingly, there is a desire for a method that enables a low- power user terminal to effectively perform an object based audio service, and may support a backward compatibility even though the low-performance user terminal is incapable of performing the object based audio service. Also, there is a desire for a method that enables a user terminal to perform an object based audio service even though audio objects are entirely mixed.

### SUMMARY

An aspect of the present invention provides an apparatus and method that enables a low-performance user terminal to effectively perform an object based audio service.

Another aspect of the present invention also provides an apparatus and method that may support a backward compatibility by extracting and playing back an audio object even though a user terminal is incapable of performing an object based audio service.

According to an aspect of the present invention, there is provided a method of playing back an object based audio file, performed by an object based audio file playback apparatus, the method including: receiving the object based audio file comprising a file header for an object based audio service, a frame corresponding each of audio objects, and a frame corresponding a audio source in which all of the audio objects are mixed; and playing back the object based audio file by controlling, based on a specification of the object based audio file playback apparatus, the audio source in which all of the audio objects are mixed.

According to another aspect of the present invention, there is provided an apparatus for playing back an object based audio file, the apparatus including: an audio file receiver to receive the object based audio file comprising a file header for an object based to audio service, a frame corresponding each of audio objects, and a frame corresponding a audio source in which all of the audio objects are mixed; and an audio file playback unit to play back the object based audio file by controlling, based on a specification of the object based audio file playback apparatus, the audio source in which all of the audio objects are mixed.

According to still another aspect of the present invention, there is provided a method of playing back an object based audio file, performed by an object based audio file playback apparatus, the method including: decoding at least one down-mixed audio track in the object based audio file; and selecting and playing back the at least one down-mixed audio track.

According to yet another aspect of the present invention, there is provided a method of playing back an object based audio file, performed by an object based audio file playback apparatus, the method including: decoding at least one audio track for each audio object, included in the object based audio file; and playing back an audio track selected by a user from the at least one audio track for each audio object.

According to a further another aspect of the present invention, there is provided a method of playing back an object based audio file, performed by an object based audio file playback apparatus, the method including: decoding a plurality of audio tracks for each of a plurality of audio objects, at least one down-mixed audio track in which the plurality of audio objects is down mixed, and an audio track for enhancing sound quality, included in the object based audio file; estimating an audio object excluded from the object based audio file among audio objects included in the at least one down-mixed audio track; and playing back an audio track corresponding to the estimated audio track and the plurality of audio tracks for each audio object.

According to still another aspect of the present invention, there is provided an apparatus for playing back an object based audio file, the apparatus including: an audio file decoding unit to decode at least one down-mixed audio track in the object based audio file; and an audio file playback unit to select and play back the at least one down-mixed audio track.

According to still another aspect of the present invention, there is provided an apparatus for playing back an object based audio file, the apparatus including: an audio file decoding unit to decode at least one audio track for each audio object, included in the object based audio file; and an audio file playback unit to play back an audio track selected by a user from the at least one audio track for each audio object.

According to still another aspect of the present invention, there is provided an apparatus for playing back an object based audio file, the apparatus including: an audio file decoding unit to decode a plurality of audio tracks for each of a plurality of audio objects, at least one down-mixed audio track in which the plurality of audio objects is down mixed, and an audio track for enhancing sound quality, included in the object based audio file,; and an audio file playback unit to estimate an audio object excluded from the object based audio file among audio objects included in the at least one down-mixed audio track, and to play back an audio track corresponding to the estimated audio track and the plurality of audio tracks for each audio object.

According to still another aspect of the present invention, there is provided a non-transitory computer-readable recording medium, wherein audio service classification information associated with classifying of audio tracks included in an object based audio file is stored in one of an audio file, a movie box, and a meta box existing within an audio track.

According to still another aspect of the present invention, there is provided a non-transitory computer-readable recording medium, wherein audio service classification information associated with classifying of audio tracks included in an object based audio file is stored in one of an audio file and a new box within a movie box.

### EFFECT

According to embodiments of the present invention, a low-performance user terminal may effectively perform an object based audio service.

According to embodiments of the present invention, when a number of audio objects played back by a low-performance user terminal is limited, the low-performance user terminal may effectively perform an object based audio service.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus for providing an object based audio file, and an apparatus for playing back the object based audio file according to an embodiment of the present invention;

FIG. 2 is a block diagram illustrating a configuration of the apparatus for providing the object based audio file, and the apparatus for playing back the object based audio file of FIG. 1;

FIG. 3 is a diagram illustrating a format of a bitstream about an object based audio file according to an embodiment of the present invention;

FIG. 4 is a diagram illustrating a format of a bitstream about an object based audio file according to another embodiment of the present invention;

FIG. 5 is a diagram illustrating a format of a bitstream about an object based audio file according to still another embodiment of the present invention;

FIG. 6 is a flowchart illustrating a method of providing an object based audio file according to an embodiment of the present invention;

FIG. 7 is a flowchart illustrating a method of playing back an object based audio file according to an embodiment of the present invention;

FIG. 8 is a diagram to describe a process of playing back an object based audio file according to an embodiment of the present invention;

FIG. 9 is a diagram to describe a process of playing back an object based audio file according to another embodiment of the present invention;

FIG. 10 is a diagram to describe a process of playing back an object based audio file according to still another embodiment of the present invention; and

FIG. 11 is a block diagram illustrating an apparatus for playing back an object based audio file according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

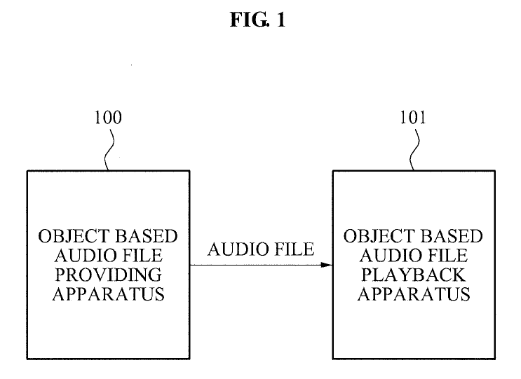

FIG. 1 is a block diagram illustrating an apparatus 100 for providing an object based audio file, and an apparatus 101 for playing back the object based audio file according to an embodiment of the present invention.

The object based audio file providing apparatus 100 and the object based audio file playback apparatus 101 may process an audio file comprising a plurality of audio tracks. For example, the object based audio file providing apparatus 100 may provide, to the object based audio file playback apparatus 101, a bitstream about the audio file. The object based audio file playback apparatus 101 may extract the audio file from the bitstream, and may play back the audio tracks included in the audio file. Here, an audio track may be generated for each audio object corresponding to a audio source.

According to an embodiment of the present invention, there is provided a method that may perform an object based audio service when the object based audio file playback apparatus 101 may play back only a limited number of audio objects like a user terminal having a low-performance.

Also, according to an embodiment of the present invention, there is provided a method that may play back a audio source in which a plurality of audio objects is mixed, even though the object based audio file playback apparatus 101 may not provide an object based audio service.

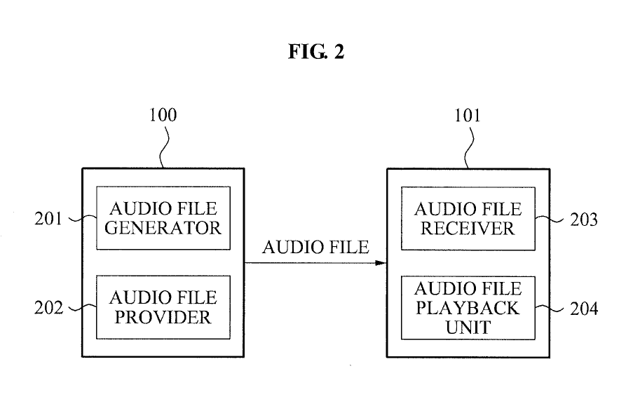

FIG. 2 is a block diagram illustrating a configuration of the apparatus 100 for providing the object based audio file, and the apparatus 101 for playing back the object based audio file of FIG. 1.

Referring to FIG. 2, the object based audio file providing apparatus 100 may include an audio file generator 201 and an audio file provider 202.

The audio file generator 201 may generate an audio file including a file header for an object based audio service, a frame corresponding each of audio objects, and a frame corresponding a audio source in which all of the audio objects are mixed. Here, the file header may include an audio preset defining an object attribute, and the object attribute may include an object position of each of the audio objects or a sound strength.

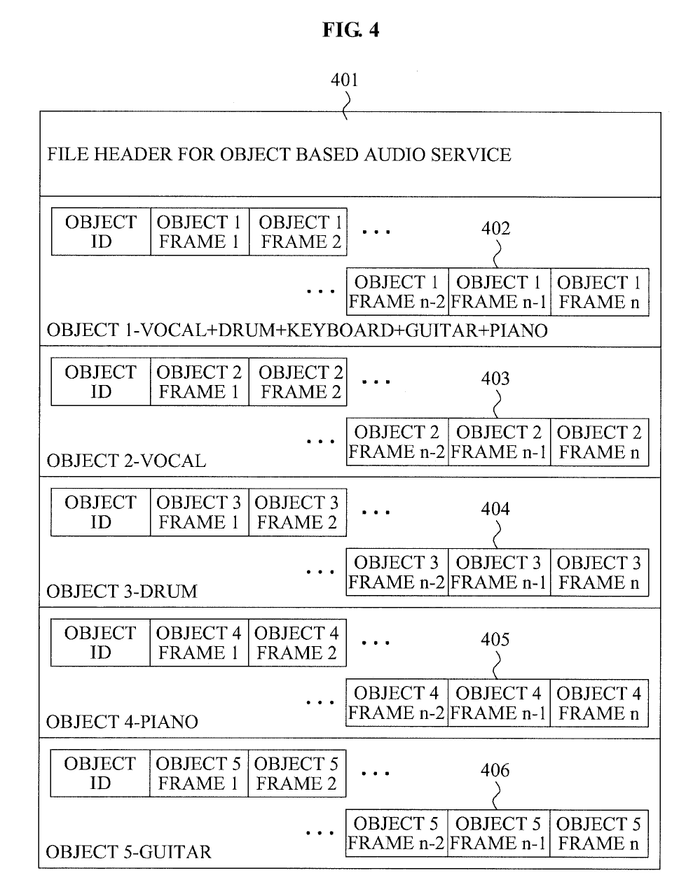

Since the audio file includes the frame storing the audio source in which all of the audio objects are mixed, the audio file may include a frame in which at least one remaining object excluding a single object from the plurality of objects are stored. This example will be further described with reference to FIG. 4.

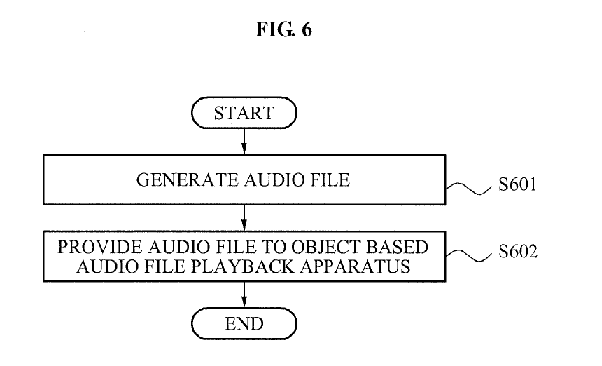

As another example, a file header for an object based audio service may be positioned in the middle of a bitstream. This example will be further described with reference to FIG. 6.

The audio file provider 202 may convert the audio file to a bitstream form and thereby transmit the converted audio file to the object based audio file playback apparatus 101.

Referring to FIG. 2, the object based audio file playback apparatus 101 may include an audio file receiver 203 and an audio file playback unit 204.

The audio file receiver 203 may receive the object based audio file including a file header for an object based audio service, a frame corresponding each of audio objects, and a frame corresponding a audio source in which all of the audio objects are mixed.

The audio file playback unit 204 may play back the object based audio file by controlling, based on a specification of the object based audio file playback apparatus 101, the audio source in which all of the audio objects are mixed.

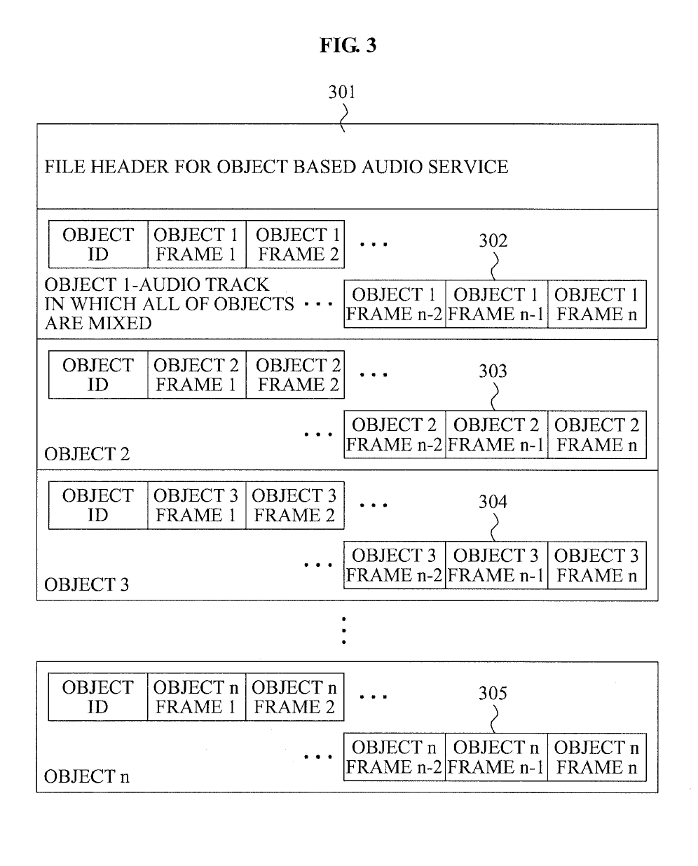

As one example, when a number of audio objects supported by the object based audio file playback apparatus 101 such as a low-performance mobile terminal is limited, the audio file playback unit 204 may play back the audio source in which all of the audio objects are mixed and an audio object desired to be played back by a user, based on the number of audio objects supportable by the object based audio file playback apparatus 101. This example will be further described with reference to FIG. 3 and FIG. 4.

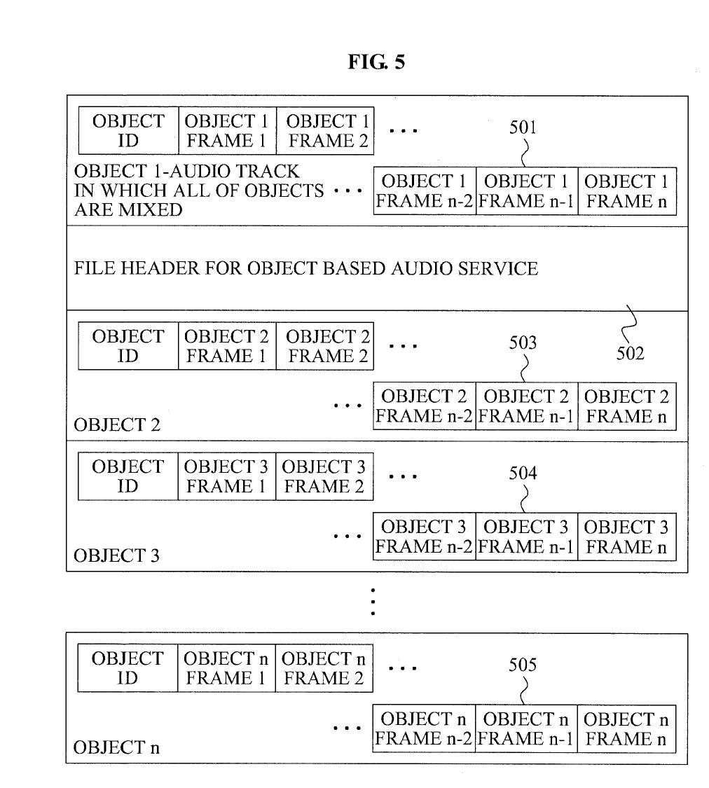

As another example, when the object based audio file playback apparatus 101 does not support the object based audio service, the audio file playback unit 204 may play back the audio source positioned ahead of the file header. Here, the audio source in which all of the audio objects are mixed may be positioned ahead of the file header for the object based audio service in the object based audio file. In this case, even though the audio file playback unit 204 may not play back an audio file positioned after the file header, the audio file playback unit 204 may play back the audio source in which all of the audio objects are mixed. This example, will be further described with reference to FIG. 5.

As still another example, when an audio object desired to be played back is excluded in the object based audio file, the audio file playback unit 204 may play back the excluded audio file using at least one remaining audio object included in the object based audio file and the audio source in which all of the audio objects are mixed. This example will be further described with reference to FIG. 4.

FIG. 3 is a diagram illustrating a format of a bitstream about an object based audio file according to an embodiment of the present invention.

Referring to FIG. 3, the bitstream may include a file header 301 for an object based audio file, and a plurality of frames for respective audio objects (hereinafter, referred to as an audio object frame). For example, an audio object frame 302 may be recorded a audio source in which all of audio objects are mixed. Here, the audio source in which all of the audio objects are mixed may be set as a single audio object. Also, since the audio source in which all of the audio objects are mixed is added, each of audio object frames 303, 304, and 305 may correspond to a frame where remaining audio objects excluding a single audio object from the plurality of audio objects are stored. Each of the audio object frames 302, 303, 304, and 305 may include an object identifier (ID) for identifying an audio object stored in a corresponding frame.

FIG. 4 is a diagram illustrating a format of a bitstream about an object based audio file according to another embodiment of the present invention. A format of the bitstream of FIG. 4 may be the same as the format of the bitstream of FIG. 3.

As shown in FIG. 4, a plurality of audio objects may correspond to a vocal, a drum, a keyboard, a guitar, and a piano. An audio object 1 may correspond to a audio source in which all of the audio objects, for example, the vocal, the drum, the keyboard, the guitar, and the piano are mixed. The audio object 1 may be stored in an audio object frame 402.

The plurality of audio objects may be stored in a plurality of audio object frames 403, 404, 405, and 406. Here, instead of storing all of the audio objects in the audio object frames 403, 404, 405, and 406, a single audio object may be excluded from the plurality of audio objects. For example, in FIG. 4, the piano is excluded.

According to an embodiment of the present invention, even though all of audio objects are not stored in audio object frames, a audio source in which all of the audio objects are mixed may be stored and thus, the object based audio file playback apparatus 101 may play back all of the audio objects. For example, in FIG. 4, the audio object 1 corresponds to an object in which all of the audio objects are mixed. Accordingly, when excluding, from the audio object 1, the vocal, the drum, the keyboard, and the guitar corresponding to remaining audio objects, an audio object corresponding to the piano may be extracted.

Through the above process, the object based audio file playback apparatus 101 may control each of audio objects.

audio object 1=vocal+drum+keyboard+guitar+piano piano object=audio object 1 (entire mixing)−audio object 2 (vocal)−audio object 3 (drum)−audio object 4 (keyboard)−audio object 5 (guitar)

piano object control (50% level decrease)=piano object−0.5×piano object

piano object elimination (100% level decrease)=audio object 1−piano object

vocal object control (50% level decrease)=audio object 1 (entire mixing)−0.5×audio object 2 (vocal)

vocal object elimination (100% level decrease)=audio object 1 (entire mixing)−audio object 2 (vocal)

vocal object control (50% level increase)=audio object 1 (entire mixing)+0.5×audio object 2 (vocal)

drum object control (30% level decrease), guitar object control (20% level increase)=audio object 1 (entire mixing)−0.3×audio object 3 (drum)+0.2×audio object 5 (guitar) Ex)

Here, it is assumed that the object based audio file playback apparatus 101 corresponds to a user terminal, and may play back a maximum of three audio objects in real time. In this case, the object based audio file playback apparatus 101 may basically play back the audio object 1 that is the audio source in which all of the audio objects are mixed, and two audio objects selected by a user. The user may control the selected two objects at the user's desired value and thereby may play back the two objects.

CASE 1) where the object based audio file playback apparatus 101 corresponds to a user terminal supporting two objects:

play back audio object 1 (entire mixing) and audio object 2 (vocal)←a user can adjust a level of the vocal

play back audio object 1(entire mixing) and audio object 3 (drum)←a user can adjust a level of the drum

CASE 2) where the object based audio file playback apparatus 101 corresponds to a user terminal supporting three objects:

play back audio object 1 (entire mixing), audio object 2 (vocal), and audio object 3 (drum)←a user can adjust a level of the vocal and the drum

play back audio object 1 (entire mixing), audio object 2 (vocal), and audio object 4 (keyboard)←a user can adjust level of the vocal and the keyboard

When an existing mobile terminal incapable of providing the object based audio service plays only the audio object 1 through firmware upgrade, a backward compatibility may be provided. For example, the audio object 1 corresponds to the audio source in which all of audio objects are mixed. Accordingly, when the bitstream of FIG. 3 informs a conventional user terminal about a position of the audio object 1 within the bitstream through an firmware upgrading scheme and the like, the audio source in which all of the audio objects are mixed may be provided.

FIG. 5 is a diagram illustrating a format of a bitstream about an object based audio file according to still another embodiment of the present invention.

FIG. 5 illustrates a case where a file header 502 is positioned in the middle of the bitstream about the object based audio file. In FIG. 5, the object based audio file playback apparatus 101 may correspond to an apparatus incapable of playing back an audio object for an object based audio service.

In the bitstream of FIG. 5, an audio object 1 corresponding to the audio source in which all of the audio objects are mixed may be positioned ahead of the file header 502. In this case, even though the object based audio file playback apparatus 101 may not play back audio objects for the object based audio service that are positioned behind the file header 502, the object based audio file playback apparatus 101 may play back an audio object 1 included in an audio object frame 501 and thereby provide the user with the object based audio service. According to an embodiment of the present invention, a user terminal incapable of performing the object based audio terminal may play back the audio source in which all of the audio objects are mixed.

The object based audio file playback apparatus 101 may not play back the file header 502 or remaining audio objects included in audio object frames 503, 504, and, 505. Here, the file header 502 may include an audio preset defining an object attribute such as an object position of each audio object or a sound strength.

FIG. 6 is a flowchart illustrating a method of providing an object based audio file according to an embodiment of the present invention.

In operation S601, the object based audio file playback apparatus 101 of FIG. 1 may generate the object based audio file including a file header for an object based audio service, to a frame corresponding each of audio objects, and a frame corresponding a audio source in which all of the audio objects are mixed.

Due to a frame storing the audio source in which all of audio objects are mixed, the audio file may include a frame in which each of at least one remaining audio object excluding a single audio object from the plurality of audio object is stored.

For example, a file header for an object based audio service may be positioned in the middle of a bitstream.

The file header for the object based audio service may include an audio preset defining an object attribute. The object attribute may include an object position of each of the audio objects or a sound strength.

In operation S602, the object based audio file providing apparatus 100 may transmit, to the object based audio file playback apparatus 101, a bitstream about the audio file.

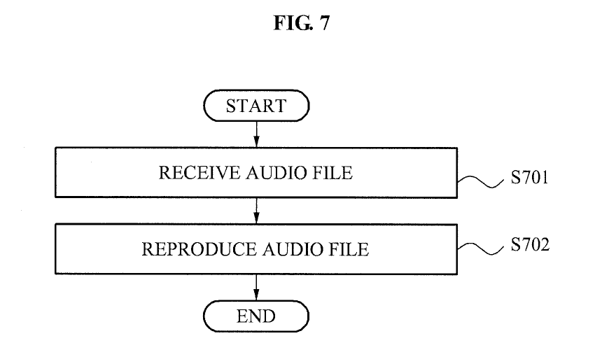

FIG. 7 is a flowchart illustrating a method of playing back an object based audio file according to an embodiment of the present invention.

In operation S701, the object based audio file playback apparatus 101 may receive the object based audio file including a file header for an object based audio service, a frame corresponding each of audio objects, and a frame corresponding a audio source in which all of the audio objects are mixed.

Here, due to a frame storing the audio source in which all of audio objects are mixed, the audio file may include a frame in which each of at least one remaining audio object excluding a single audio object from the plurality of audio object is stored.

In operation S702, the object based audio file playback apparatus 101 may play back the audio source in which all of the audio objects are mixed and an audio object desired by a user, based on a number of supportable audio objects. It may correspond to a case where a number of audio objects supported by the object based audio file playback apparatus 101 is limited.

As another example, the audio source in which all of the audio objects are mixed may be positioned ahead of the file header for the object based audio service in the object based audio file. In this case, the object based audio file playback apparatus 101 not supporting the object based audio service may play back the audio source positioned ahead of the file header.

When an audio object desired to be played back is excluded in the object based audio file, the object based audio file playback apparatus 101 may play back the excluded audio object using the audio source in which all of the audio objects are mixed and at least one remaining audio object included in the object based audio file.

Hereinafter, a method of supporting a backward compatibility using a scheme different from description made with reference to FIG. 1 through FIG. 10 will be described.

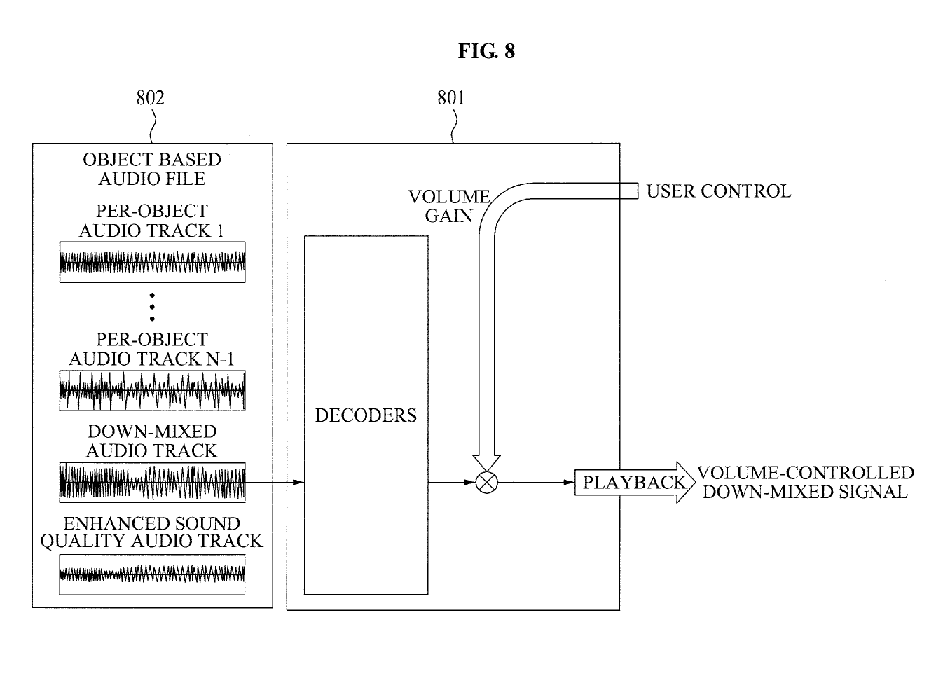

Terms used in FIG. 8 through FIG. 11 may be defined as follows:

An object based audio file may include a variety of audio tracks, and may include at least one of an audio track for each audio object, a down-mixed audio track, and an enhanced sound quality audio track. The audio track may indicate a playback target for each audio object, and may be included in the object based audio file. When n objects are present, a number of audio tracks may be n. The down-mixed audio track indicates that at least one audio track is down mixed. The enhanced sound quality audio track indicates that a sum of audio tracks used for down-mixing is excluded in the down-mixed audio track. The enhanced sound quality audio track may be used to remove, in the down-mixed audio track, an effect about de-clipping or mastering occurring when producing the down-mixed audio track.

FIG. 8 is a diagram to describe a process of playing back an object based audio file 802 according to an embodiment of the present invention.

Referring to FIG. 8, an object based audio file playback apparatus 801 may select a down-mixed audio track suitable for an audio service, and decode the selected down-mixed audio track, and thereby may provide the audio service to a user.

In FIG. 8, even though the object based audio file playback apparatus 801 may parse the object based audio file 802, decoding may not be performed with respect to a plurality of audio tracks. In this case, the object based audio file playback apparatus 801 may decode and thereby play back a down-mixed audio track in which audio tracks for each of the audio objects are down mixed, in the object based audio file 802.

When a plurality of down-mixed audio tracks are present in the object based audio file 802, the object based audio file playback apparatus 801 may play back a selected down-mixed audio track. Here, the object based audio file playback apparatus 801 may play back a down-mixed audio track of which a volume gain is adjusted according to a control of the user. In the object based audio file 802, the down mixed audio track may be identified using an ID

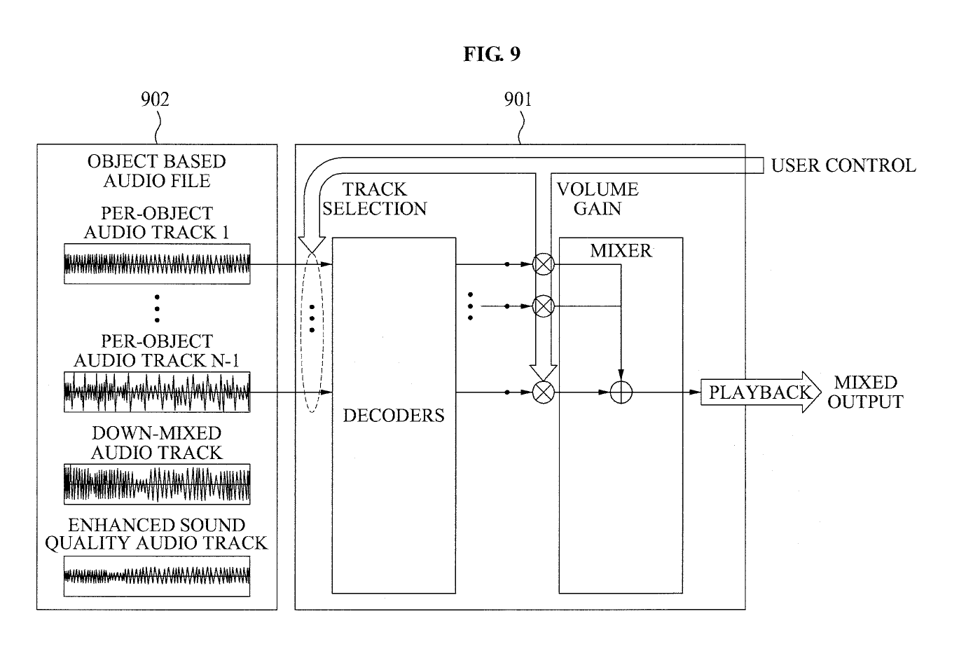

FIG. 9 is a diagram to describe a process of playing back an object based audio file 902 according to another embodiment of the present invention.

Referring to FIG. 9, an object based audio file playback apparatus 901 may decode and thereby play back audio tracks for each of the audio objects, selected from the object based audio file 902. The object based audio file playback apparatus 901 may limitlessly play back N audio tracks for each of the audio objects included in the object based audio file 902. For example, the object based audio file playback apparatus 901 may play back audio tracks for each of the audio objects, selected from all the audio tracks for each of the audio objects included in the object based audio file 902, according to a control of a user.

Here, a audio tracks for each of the audio objects to be played back may be an audio track selected by the user. When at least two audio tracks for each of the audio objects are selected, a volume of each of the at least two audio tracks for each of the audio objects may be controlled according to the control of the user and then be mixed through a mixer and then be played back audio tracks for each of the audio objects may be stored to be individually controllable in the object based audio file 902 when producing the object based audio file 902.

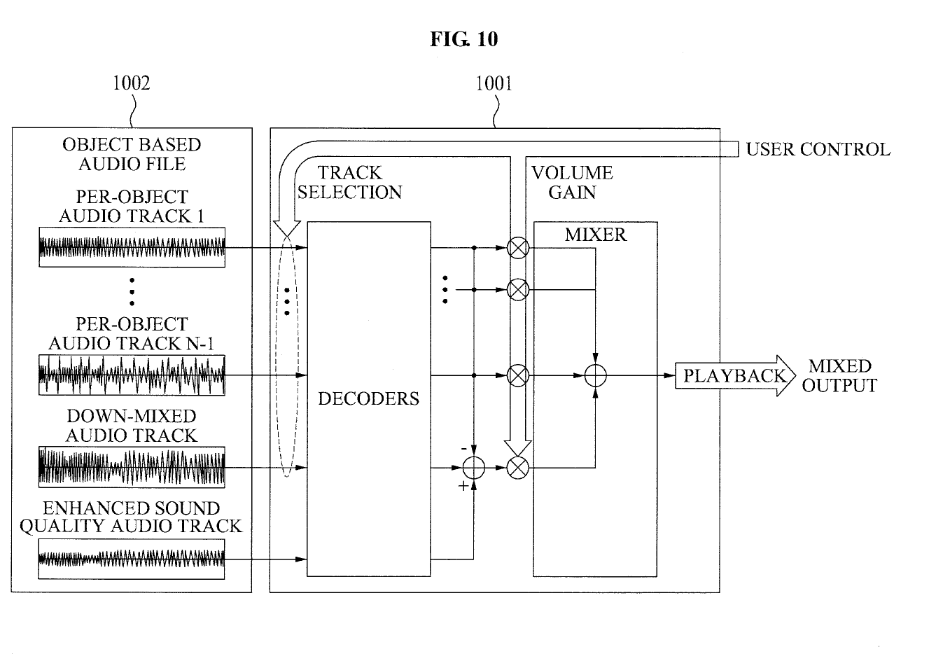

FIG. 10 is a diagram to describe a process of playing back an object based audio file 1002 according to still another embodiment of the present invention.

Referring to FIG. 10, a number of audio tracks for each of the audio objects decodable by an object based audio file playback apparatus 1001 may be limited, which is different from the object based audio file playback apparatus 901 of FIG. 9. For example, it may be assumed that the object based audio file playback apparatus 901 may decode N audio tracks for each of the audio objects, and the object based audio file playback apparatus 1001 may decode (N-1) audio tracks.

In FIG. 10, the object based audio file playback apparatus 1001 may decode audio tracks for each of the audio objects, a down-mixed audio track, and an enhanced sound quality audio track that are included in the object based audio file 1002. In this case, using the decoded down-mixed audio track and audio tracks for each of the audio objects, the audio the object based audio file playback apparatus 1001 may estimate at least one of audio tracks for each of the audio objects that is included in the down-mixed audio file, however, is excluded from the object based audio file 1002. The estimated audio tracks for each of the audio objects may be provided to be selectable by the user. In this case, the audio tracks for each of the audio objects and the down-mixed audio track may be selected through the control of the user. Accordingly, the object based audio file playback apparatus 1001 having some constraints may play back the audio tracks for each of the audio objects that is included in the down-mixed audio track, however, is excluded from the object based audio file 1002, through an additional processing process.

The additional processing process may be described as below. It may be assumed that a down-mixed audio track A, audio tracks B and C, and an enhanced sound quality audio track E are stored in the object based audio file 1002.

A=f(vocal (B)+guitar (C)+drum (D))

B=vocal

C=guitar

E=(B+C+D)−A (audio track for enhanced sound quality, E=(B+C+D)−f(B+C+D))

A denotes the down-mixed audio track and may be determined by A=f(B+C+D), and f(·) denotes a linear or non-linear function by de-clipping and/or mastering. Each of B and C denotes a audio track for audio object, and E denotes an enhanced sound quality audio track and may be determined by E=(B+C+D)−f(B+C+D).

The object based audio file playback apparatus 1001 may estimate an audio track about a drum by decoding A, B, C, and E and then performing an additional process of A−(B+C)+E. The estimated audio track for the drum may be provided to the user. The object based audio file playback apparatus 1001 may decode and thereby play back audio tracks for each of the audio objects according to a control of the user. For example, 50% level decrease about the drum may be processed by (A−(B+C)+E)×0.5, whereby the audio track may be played back.

Also, when the audio tracks B and C or the down-mixed audio track A are stored in the object based audio file 1002 as an inverted signal (ex., a signal multiplied by −1), the object based audio file playback apparatus 1001 may estimate the audio track about the drum by decoding A, B, and C and then performing processing of A+(B+C)+E. As a result, the estimated audio track about the drum may be provided to the user. In this case, the audio track in an inverted form may be played back in the object based audio file playback apparatus 1001 without deteriorating a sound quality. The object based audio file playback apparatus 1001 may play back the audio tracks for each of the audio objects without performing an operation of multiplying each audio tracks for each of the audio objects by “−1”.

In FIG. 8 through FIG. 10, audio service classification information may be stored within a corresponding illustrated object based audio file so that an audio track corresponding to a service type of an object based audio file playback apparatus may be decoded together with a down-mixed audio track in which audio tracks for each of the audio objects are pre-synthesized, that is, mixed and/or mastered. For example, the audio service classification information may indicate header information used to identify the down-mixed audio track and the audio tracks for each of the audio objects.

Since the audio service classification information is stored in the object based audio file, a conventional object based audio file playback apparatus capable of parsing an object based audio file may select and thereby play back the down-mixed audio track stored in the object based audio file. Even though not all the audio tracks for each of the audio objects are stored in the object based audio file, the object based audio file playback apparatus may estimate audio tracks about objects not stored in the object based audio file by performing additional processing using the down-mixed audio track. In this case, the user may select and thereby play back the estimated audio track that is excluded from the object based audio file. Accordingly, the object based audio file may be effectively stored and thereby be transmitted.

The audio service classification information may be stored in the object based audio file using the following schemes:

First, audio service classification information corresponding to each level may be stored in audio file, movie box (‘moov’), or a meta box existing within each track (‘track’).

Second, audio service classification information may be stored in an audio file or a new box (‘box’) defined within a movie box (‘moov’). According to the second scheme, an object based audio file playback apparatus may verify an audio service available in an object based audio file, without a need to find all of header information associated with a track for each audio object.

When an object based audio file is played back in an existing object based audio file playback apparatus, audio service classification information contained in the box may be used. In this case, it is possible to readily search for a down-mixed audio track without a need to verify header information of each audio track.

Also, when a audio tracks for each of the audio objects not stored in the object based audio file is estimated using media data of a down-mixed audio track and media data of the audio tracks for each of the audio objects, and the estimated audio track is provided to the user, a title of the estimated audio track title_other may be provided.

A syntax and semantics related thereto will follow as:

Music Service Header Box

Box Type: ‘mshd’

Container: File or Movie Box (‘moov’)

Mandatory: Yes

Quantity: Exactly one

Syntax

```
aligned(8) class MusicServiceHeaderBox extends
FullBox(‘mshd’, version=0, flags)
{
  if (flags == 2)
      unsigned int(8) num_mixed_track_ID;
      unsigned int(32) mixed_track_ID[num_mixed_track_ID];
      unsigned int(8) dependency_type;
    if (dependency_type == 2)
  unsigned int(32) enhanced_track_ID;
        string title_other;
      end
    end
  }
```

Semantics

version: version of box.

flags: indicates type information of an audio service available as an 8-bit flag.

Service_noncompatibility: indicates not providing of a compatibility with a conventional object based audio file playback apparatus that may parse an object based audio file, however, may not decode a plurality of audio tracks, and supporting of a new object based audio file playback apparatus. When a flag value is 0×01, it indicates that a down-mixed audio track decodable by the conventional object based audio file playback apparatus does not exist in the object based audio file.

Service_compatibility: indicates providing of a compatibility with a conventional object based audio file playback apparatus that may parse an object based audio file, however, may not decode a plurality of audio tracks. When a flag value is 0×02, it indicates that a down-mixed audio track decodable by the conventional object based audio file playback apparatus exists in the object based audio file.

| Flags | meaning |
|---|---|
| 0x01 | Supporting compatibility with only a new object based |
| | audio file playback apparatus. |
| 0x02 | Supporting compatibility with not only the new object |
| | based audio file playback apparatus, but also a |
| | conventional object based audio file playback |
| | apparatus that may parse an object based audio |
| | file, however, may not decode a plurality of |
| | audio tracks. |

num_mixed_track_ID: indicates a number of down-mixed audio tracks.

mixed_trackID[num_mixed_track_ID]: indicates an ID of a corresponding down-mixed audio track.

dependency_type: indicates whether a down-mixed audio track is to be used in decoding an independently controllable audio track for each of audio objects in order to provide an object based audio service.

| dependency_type | meaning |
|---|---|
| 0x01 | Decoding audio tracks for each of the audio objects |
| | excluding a down-mixed audio track to be |
| | individually controllable by a user, when |
| | providing an object based audio service. |
| 0x02 | Decoding not only the audio tracks for each of the |
| | audio objects but also the down-mixed |
| | audio track when providing an object |
| | based audio service. When a plurality |
| | of down-mixed audio tracks exists, a down- |
| | mixed audio track having a smallest ID |
| | may be decoded. A audio tracks for each |
| | of the audio objects excluded from the |
| | object based audio file may be provided to |
| | the user through additional processing. |

enhanced_track_ID: indicates an ID of an enhanced sound quality audio track. When enhanced_track does not exist in the object based audio file, it may correspond to a value of “0”.

title_other: indicates a title of an audio track estimated through additional processing between the decoded down-mixed audio track and audio tracks for each of the audio objects.

Third, audio service compatibility information may be included in a file of the object based audio file or a new box defined within a movie box (‘moov’). A result of mixing a audio tracks for each of the audio objects selected through the control of the user and information used to identify a audio tracks for each of the audio objects may be stored in a track box for storing of metadata associated with presentation of each audio tracks for each of the audio objects.

Music Service Header Box

Box Type: ‘mshd’

Container: File or Movie Box (‘moov’)

Mandatory: Yes

Quantity: Exactly one

Syntax

```
  aligned(8) class MusicServiceHeaderBox extends
  FullBox(‘mshd’, version=0, flags)
{
  if (flags == 3)
  string title_other;
  end
  }
```

Semantics

version: version of box.

flags: indicates type information of an audio service available as an 8-bit flag.

Service_noncompatibility: indicates not providing of a compatibility with a conventional object based audio file playback apparatus that may parse an object based audio file, however, may not decode a plurality of audio tracks, and supporting of a new object based audio file playback apparatus. When a flag value is 0×01, it indicates that a down-mixed audio track decodable by the conventional object based audio file playback apparatus does not exist in the object based audio file.

Service_compatibility: indicates providing of a compatibility with a conventional object based audio file playback apparatus that may parse an object based audio file, however, may not decode a plurality of audio tracks. When a flag value is 0×02 and 0×03, it indicates that a down-mixed audio exists in the object based audio file.

| Flags | meaning | |
|---|---|---|
| 0x01 | Supporting compatibility with only a new object based audio file playback apparatus. | |
| 0x02 | Supporting | Decoding a audio tracks for each of the audio objects |
| | compatibility with not | excluding a down-mixed audio track to be individually |
| | only the new object | controllable by a user, when providing an object based audio |
| | based audio file | service. |
| 0x03 | playback apparatus, | Decoding not only the audio tracks for each of the audio |
| | but also a | objects, but also the down-mixed audio track and the |
| | conventional object | enhanced sound quality audio track when providing an |
| | based audio file | object based audio service. When a plurality of down- |
| | playback apparatus | mixed audio tracks exists, a down-mixed audio track having |
| | that may parse an | a smallest ID may be decoded. By performing additional |
| | object based audio | processing with respect to a decoded result, an audio track |
| | file, however, may not | excluded from audio tracks for each of the audio objects |
| | decode a plurality of | stored in the object based audio file may be estimated and |
| | audio tracks. | thereby be provided to be controllable by the user. |

title_other: indicates a title of an audio track estimated through additional processing between the decoded down-mixed audio track and audio tracks for each of the audio objects.

Audio Track Header Box

Box Type: ‘athd’

Container: Media Information Box (‘mini’)

Mandatory: Yes

Quantity: Exactly one

Syntax

aligned(8) class AudioTrackHeaderBox extends Box(‘athd’){
unsigned int(8) audio_track_type;
}

Semantics

audio_track_type: indicates a service characteristic of the present track.

Track_mixed: indicates a down-mixed audio track. A flag value is 0×01.

Track_individual: indicates an individually controllable audio tracks for each of the audio objects. A flag value is 0×02.

Track_enhanced: indicates an enhanced sound quality audio track. Where a flag value is 0×03, only when a audio tracks for each of the audio objects having a Track_mixed flag exists in the object based audio file, a audio tracks for each of the audio objects having a Track_enhanced flag may exist. An inverse case thereof may not be established.

A file format of the aforementioned object based audio file may be shown in the following Table 1:

TABLE 1

| | | | | | | | |
|---|---|---|---|---|---|---|---|
| * | ftyp | | | | | | file type and compatibility |
| * | moov | | | | | | container for all the metadata |
| | | mvhd | | | | | movie header, overall declarations |
| * | | mshd | | | | | music service header, overall declarations regarding audio |
| | | | | | | | service type and related information |
| | | Trak | | | | | container for an individual track or stream |
| * | | | tkhd | | | | track header, overall information about the track |
| | | | tref | | | | track reference container |
| | | | edts | | | | edit list container |
| | | | | elst | | | an edit list |
| * | | | mdia | | | | container for the media information in a track |
| * | | | | mdhd | | | media header, overall information about the media |
| * | | | | hdlr | | | handler, declares the media (handler) type |
| | | | | | | | “soun” for audio data |
| | | | | | | | “text” for timed text data |
| | | | | | | | “hint” for protocol hint track |
| * | | | | minf | | | media information container |
| * | | | | | athd | | audio track header, overall information (sound track only) |
| | | | | | smhd | | sound media header, overall information (sound track |
| | | | | | | | only) |
| | | | | | hmhd | | hint media header, overall information (hint track only) |
| | | | | | nmhd | | Null media header, overall information (some tracks only) |
| * | | | | | dinf | | data information box, container |
| * | | | | | | dref | data reference box, declares source(s) of media data in |
| | | | | | | | track |
| * | | | | | stbl | | sample table box, container for the time/space map |
| * | | | | | | stsd | sample descriptions (codec types, initialization etc.) |
| * | | | | | | stts | (decoding) time-to-sample |
| * | | | | | | stsc | sample-to-chunk, partial data-offset information |
| | | | | | | stsz | sample sizes (framing) |
| | | | | | | stz2 | compact sample sizes (framing) |
| * | | | | | | stco | chunk offset, partial data-offset information |
| | | | | | | co64 | 64-bit chunk offset |
| | | grco | | | | | container for the groups |
| | | | grup | | | | group box, describes the structure (hierarchy) |
| * | | Prco | | | | | container for the presets |
| * | | | Prst | | | | preset box, container for the preset information |
| | | Ruco | | | | | container for rules |
| | | | rusc | | | | selection rule box, container for a selection rule |
| | | | rumx | | | | mixing rule box, container for a mixing rule |
| | mdat | | | | | | media data container |
| | free | | | | | | free space |
| | skip | | | | | | free space |
| | meta | | | | | | Metadata |
| * | | hdlr | | | | | handler, declares the metadata (handler) type |
| | | dinf | | | | | data information box, container |
| | | | dref | | | | data reference box, declares source(s) of metadata items |
| | | iloc | | | | | item location |
| | | iinf | | | | | item information |
| | | xml | | | | | XML container |
| | | bxml | | | | | binary XML container |
| | | pitm | | | | | primary item reference |

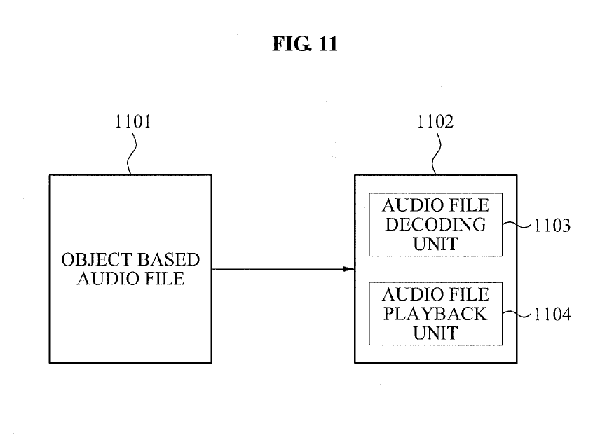

FIG. 11 is a diagram illustrating an apparatus 1102 for playing back an object based audio file according to another embodiment of the present invention.

Referring to FIG. 11, the object based audio file playback apparatus 1102 may include an audio file decoding unit 1103 and an audio file playback unit 1104.

As one example, the audio file decoding unit 1103 may decode at least one down-mixed audio track in the object based audio file 1101. The audio file playback unit 1104 may select and play back the at least one down-mixed audio track.

As another example, the audio file decoding unit 1103 may decode at least one audio track for each audio object, included in the object based audio file 1101. The audio file playback unit 1104 may play back an audio track selected by a user from the at least one audio track for each audio object.

As still another example, the audio file decoding unit 1103 may decode a to plurality of audio tracks for each of a plurality of audio objects, at least one down-mixed audio track in which the plurality of audio objects is down mixed, and an audio track for enhancing sound quality, included in the object based audio file. The audio file playback unit 1104 may estimate an audio object excluded from the object based audio file among audio objects included in the at least one down-mixed audio track, and may play back an audio track corresponding to the estimated audio track and the plurality of audio tracks for each audio object. In an example of FIG. 11, audio tracks may be played back by applying a user-adjusted gain to the audio tracks.

The above-described exemplary embodiments of the present invention may be recorded in computer-readable media including program instructions to implement various operations embodied by a computer. The media may also include, alone or in combination with the program instructions, data files, data structures, and the like. The program instructions stored in the media may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of playing back an object based audio file, performed by an object based audio file playback apparatus, the method comprising:
receiving the object based audio file comprising a file header for an object based audio service, a frame corresponding each of audio objects, and a frame corresponding a audio source in which all of the audio objects are mixed; and
playing back the object based audio file by controlling, based on a specification of the object based audio file playback apparatus, the audio source in which all of the audio objects are mixed.

2. The method of claim 1, wherein the playing back comprises playing back the audio source in which all of the audio objects are mixed and at least one of audio object desired to be played back by a user, based on a number of audio objects supportable by the object based audio file playback apparatus.

3. The method of claim 1, wherein:
the audio source in which all of the audio objects are mixed is positioned ahead of the file header for the object based audio service in the object based audio file, and
the playing back comprises playing back the audio source positioned ahead of the file header when the object based audio file playback apparatus does not support the object based audio service.

4. The method of claim 1, wherein the playing back comprises playing back an audio object desired to be played back in the object based audio file, using the audio source in which all of the audio objects are mixed and at least one remaining audio file included in the object based audio file when the desired audio object is excluded.

5. The method of claim 1, wherein the file header comprises an audio preset defining an object attribute, and the object attribute comprises at least one of an object position of each of the audio objects and a sound strength of each of the audio objects.

6. An apparatus for playing back an object based audio file, the apparatus comprising:
an audio file receiver to receive the object based audio file comprising a file header for an object based audio service, a frame corresponding each of audio objects, and a frame corresponding a audio source in which all of the audio objects are mixed; and
an audio file playback unit to play back the object based audio file by controlling, based on a specification of the object based audio file playback apparatus, the audio source in which all of the audio objects are mixed.

7. The apparatus of claim 6, wherein the audio file playback unit plays back the audio source in which all of the audio objects are mixed and at least one of an audio object desired to be played back by a user, based on a number of audio objects supportable by the object based audio file playback apparatus.

8. The apparatus of claim 6, wherein:
the audio source in which all of the audio objects are mixed is positioned ahead of the file header for the object based audio service in the object based audio file, and
when the object based audio file playback apparatus does not support the object based audio service, the audio file playback unit plays back the audio source positioned ahead of the file header.

9. The apparatus of claim 6, wherein when an audio object desired to be played back in the object based audio file is excluded, the audio file playback unit plays back the excluded audio file using the audio source in which all of the audio objects are mixed and at least one remaining audio file included in the object based audio file.

10. The apparatus of claim 6, wherein the file header comprises an audio preset defining an object attribute, and the object attribute comprises at least one of an object position of each of the audio objects and a sound strength of each of the audio objects.

11. A method of playing back an object based audio file, performed by an object based audio file playback apparatus, the method comprising:
decoding at least one down-mixed audio track in the object based audio file; and
selecting and playing back the at least one down-mixed audio track.

12. A method of playing back an object based audio file, performed by an object based audio file playback apparatus, the method comprising:
decoding at least one audio track for each audio object, included in the object based audio file; and
playing back an audio track selected by a user from the at least one audio track for each audio object.

13. A method of playing back an object based audio file, performed by an object based audio file playback apparatus, the method comprising:
decoding a plurality of audio tracks for each of a plurality of audio objects, at least one down-mixed audio track in which the plurality of audio objects is down mixed, and an audio track for enhancing sound quality, included in the object based audio file;
estimating an audio object excluded from the object based audio file among audio objects included in the at least one down-mixed audio track; and
playing back an audio track corresponding to the estimated audio track and the plurality of audio tracks for each audio object.

14. The method of claim 13, wherein the playing back comprises playing back a corresponding audio object by applying, to the audio object, a gain adjusted by a user.

15. An apparatus for playing back an object based audio file, the apparatus comprising:
an audio file decoding unit to decode at least one down-mixed audio track in the object based audio file; and
an audio file playback unit to select and play back the at least one down-mixed audio track.

16. An apparatus for playing back an object based audio file, the apparatus comprising:
an audio file decoding unit to decode at least one audio track for each audio object, included in the object based audio file; and
an audio file playback unit to play back an audio track selected by a user from the at least one audio track for each audio object.

17. An apparatus for playing back an object based audio file, the apparatus comprising:
an audio file decoding unit to decode a plurality of audio tracks for each of a plurality of audio objects, at least one down-mixed audio track in which the plurality of audio objects is down mixed, and an audio track for enhancing sound quality, included in the object based audio file,; and
an audio file playback unit to estimate an audio object excluded from the object based audio file among audio objects included in the at least one down-mixed audio track, and to play back an audio track corresponding to the estimated audio track and the plurality of audio tracks for each audio object.

18. The apparatus of claim 17, wherein the audio file playback unit plays back a corresponding audio object by applying, to the audio object, a gain adjusted by a user.

19. A non-transitory computer-readable recording medium, wherein audio service classification information associated with classifying of audio tracks included in an object based audio file is stored in one of an audio file, a movie box, and a meta box existing within an audio track.

20. A non-transitory computer-readable recording medium, wherein audio service classification information associated with classifying of audio tracks included in an object based audio file is stored in one of an audio file and a new box within a movie box.
